(19) United States
(12) Patent Application Publication
(10) Pub. No.: US 2015/0312768 A1
(43) Pub. Date: Oct. 29, 2015

(54) SMALL CELL ACCESS MODE CONTROL BASED ON DEMAND METRICS

(71) Applicant: QUALCOMM INCORPORATED, San Diego, CA (US)

(72) Inventor: Yeliz Tokgoz, San Diego, CA (US)

(73) Assignee: QUALCOMM INCORPORATED, San Diego, CA (US)

(21) Appl. No.: 14/265,160

(22) Filed: Apr. 29, 2014

(51) Int. Cl. H04W 16/04; H04W 48/06; H04W 24/08

(52) U.S. Cl. CPC H04W 16/04; H04W 24/08; H04W 48/06

(57) ABSTRACT

In a wireless communication system, a cell may perform a method for obtaining demand measurement data indicative of demand by one or more terminals for wireless service provided by the cell, and adapting a backhaul configuration of the cell based at least in part on the demand measurement data. The cell or network node may determine whether to adapt the backhaul configuration, based at least in part on the demand measurement data. The determining may include detecting a change in demand for use of the small cell by terminals that are not members of the small cell's closed subscriber group (CSG) that exceeds a threshold amount. The method may include changing an access mode of the small cell, in response to detecting the change in the demand. For example, changing the access mode may include changing from restricted access to open access, in response to detecting an increase in the demand.

### BACKGROUND

Aspects of the present disclosure relate generally to wireless communication systems, and more particularly, to controlling access modes and/or backhaul provisioning for small cells.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the LIE, and the uplink (or reverse link) refers to the communication link from the UE to the base station. A base station may be, or may include, a macrocell or small cell. Small cells are characterized by having generally much lower transmit power than macrocells, and may often be deployed without central planning. In contrast, macrocells are typically installed at fixed locations as part of a planned network infrastructure, and cover relatively large areas.

The 3rd Generation Partnership Project (3GPP) Long Term Evolution (LTE) advanced cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs. In prior applications, a method for facilitating high bandwidth communication for multimedia has been single frequency network (SFN) operation. SFNs utilize radio transmitters, such as, for example, eNBs, to communicate with subscriber UEs.

Wireless networks have seen increasing addition of small, low-power cells. Small cells may be manually provisioned at startup by the operator to operate in one of restricted access, open access, or hybrid modes. In restricted access, access is limited to UEs belonging to a closed subscriber group (CSG). In open access, access is open to any UE generally. In hybrid mode, access is open with priority given to CSG members. Different access modes may require different provisioning of backhaul services provided to a small cell. For example, an open access cell may require a backhaul with more bandwidth than a restricted access cell. Manual provisioning at start-up may restrict the network from flexible reassignment of access modes for small cells. Thus, prior provisioning methods may limit small cells from being operated in modes that optimize efficiency of the network to which a small cell belongs.

### SUMMARY

Methods, apparatus and systems for flexible backhaul provisioning and access control based on demand metrics in mixed macro and small cell wireless networks are described in detail in the detailed description, and certain aspects are summarized below. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect, a small cell may perform a method for flexible adaptation of backhaul configuration response to demand, including obtaining demand measurement data indicative of demand by one or more terminals for wireless service provided by the cell. The method may include adapting a backhaul configuration of the cell based at least in part on the demand measurement data.

In related, optional aspects, the method may further include adapting a backhaul configuration of the cell further based on a network load factor, in addition to the measure change in demand. For example, when the network is more highly loaded, threshold demand levels for adapting a backhaul for higher data rates may be increased. Conversely, when network load is low, threshold demand levels for adopting increased data rate configurations may be lowered.

In other aspects, the method may include determining whether to adapt the backhaul configuration, based at least in part on the demand measurement data. For example, the method may include detecting a change in demand for use of the small cell from terminals that are not members of the small cell's closed subscriber group (CSG) that exceeds a threshold amount, e.g., in a test loop or look-up table.

In other aspects, the method may include changing an access mode of the small cell, in response to detecting the change in the demand. For example, the method may include changing the small cell from one of restricted access or hybrid access to open access, in response to detecting an increase in the demand. Correspondingly, the method may include adapting a backhaul configuration of the cell, at least in part by increasing a backhaul capacity for the small cell, in response to changing the small cell to an open access mode. Conversely, the method may include changing the access mode at least in part by changing from open access to one of hybrid access or restricted access, in response to detecting a decrease in the demand. In such case, the method may further include adapting a backhaul configuration of the cell at least in part by decreasing a backhaul capacity for the small cell in response to changing from open access to hybrid or restricted access.

Various processes may be used for obtaining demand measurement data used for determining changes in backhaul configurations for small cells. For example, obtaining the demand measurement data may include tracking registration attempts of terminals not belonging to the small cell's CSG. In an alternative, the method may include obtaining demand measurement data by tracking completed registrations of terminals belonging to the small cell's CSG. In the alternative, or in addition, obtaining demand measurement data may include tracking a volume of traffic between terminals belonging to the small cell's CSG and the small cell. Likewise, in another option, demand measurement may include tracking a volume of traffic between terminals not belonging to the small cell's CSG and the small cell.

In related aspects, a wireless communication apparatus may be provided for performing any of the methods and aspects of the methods summarized above. An apparatus may include, for example, a processor coupled to a memory, wherein the memory holds instructions for execution by the processor to cause the apparatus to perform operations as described above. Certain aspects of such apparatus (e.g., hardware aspects) may be exemplified by a network entity, such as, for example, a base station, eNB, or small cell, alone, or in cooperation with a core network entity. In some aspects, a mobile entity and network entity may operate interactively to perform aspects of the technology as described herein. Similarly, an article of manufacture may be provided, including a computer-readable storage medium holding encoded instructions, which when executed by a processor, cause a network entity or access terminal to perform the methods and aspects of the methods as summarized above.

### BRIEF DESCRIPTION OF THE DRAWINGS

FIG. 1 is a block diagram conceptually illustrating an example of a telecommunications system.

FIGS. 2A-2B are block diagrams conceptually illustrating examples of shifts in demand affecting small cells and backhaul configuration in wireless networks.

FIG. 3 is a block diagram conceptually illustrating is a block diagram conceptually illustrating a design of a base station/eNB and a UE configured according to one aspect of the present disclosure.

FIG. 4 is a flow chart illustrating a methodology for adapting a backhaul configuration of a small cell in response to ongoing demand monitoring involving the small cell.

FIGS. 5-9 are flow charts illustrating additional operations or aspects of the methodology of FIG. 4.

FIG. 10 is a block diagram illustrating an example of an apparatus for configuring a backhaul for a small cell in response to ongoing demand monitoring, in accordance with the methodology of FIG. 4.

### DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Methods, apparatus and systems for flexible backhaul provisioning and access control in mixed macro and small cell wireless networks may include control based on demand metrics indicating levels of demand by one or more terminals for access to small cell services. In an aspect, after initial deployment in one of restricted access, open access, or hybrid modes, a small cell may perform automatic demand tracking. In restricted access, access is limited to UEs belonging to a closed subscriber group (CSG). In open access, access is open to any UE generally. In hybrid mode, access is open with priority given to CSG members.

Automatic demand tracking may include, if the small cell is operating in restricted access mode, tracking registration attempts by CSG non-members, and optionally actual registrations and traffic of CSG members. If operating in an open or hybrid access mode, the small cell tracks registrations and traffic attributable to CSG members and non-members, respectively. The small cell and/or a server in communication with a small cell, may determine one or more demand metrics based on the tracking data, the metrics indicating an extent or proportion (e.g., ratio) by which the services of the small cell are in demand by CSG non-members, whether or not the services in demand are in use by non-members. Based on the indicator(s) and optionally network load factors, the small cell and/or server determine whether the small cell should be supported by an enhanced backhaul. Optionally, the small cell and/or server may determine whether the access mode for the small cell should be changed, based on the demand metrics.

In an aspect, the technology may include determining whether to provide an enhanced backhaul capacity for the small cell, based on the demand measurement data. This determination may be made in a distributed fashion by a small cell and transmitted to a network element. The network element may cooperate with the small cell to reconfigure a backhaul link to the small cell, in accordance with the demand measurement-based determination. The small cell may change its access mode in a manner synchronized to changes in the backhaul configuration.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. The cdma2000 technology is covered by IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). The cdma2000 and UMB technologies are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

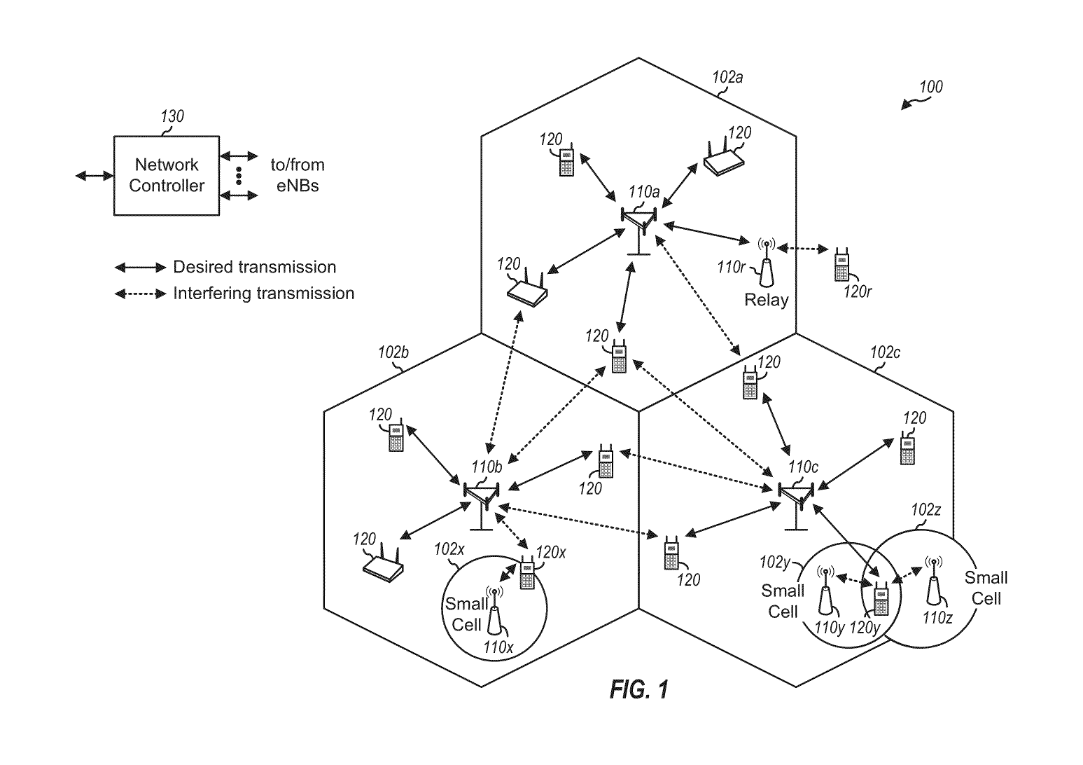

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell or a small cell (e.g., a pico cell or a femto cell) and/or other types of cell. A macro cell may cover a relatively large geographic area (e.g., several kilometers in radius) and may allow unrestricted access by UEs with service subscription. A type of small cell sometimes referred to as a “pico cell” may cover a relatively small geographic area and may allow unrestricted access by UEs with service subscription. A type of small cell sometimes referred to as a “femto cell” may cover a relatively small geographic area (e.g., a home) and may allow restricted access by UEs having association with the small cell (e.g., UEs in a Closed Subscriber Group (CSG), UEs for users in the home, etc.). An eNB for a macro cell may be referred to as a macro eNB. An eNB for a small cell may be referred to as a small cell eNB. In the example shown in FIG. 1, the eNBs 110a, 110b and 110c may be macro eNBs for the macro cells 102a, 102b and 102c, respectively. The eNB 110x may be a pico eNB for a pico cell 102x. The eNBs 110y and 110z may be small cell eNBs for the small cells 102y and 102z, respectively. An eNB may support one or multiple (e.g., three) cells. As used herein, a small cell means a cell characterized by having a transmit power substantially less than each macro cell in the network with the small cell, for example low-power access nodes such as defined in 3GPP Technical Report (T.R.) 36.932 section 4.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, small cell eNBs, relays, etc. These different types of eNBs may have different transmit power levels, different coverage areas, and different impact on interference in the wireless network 100. For example, macro eNBs may have a high transmit power level (e.g., 5 to 20 Watts) whereas small cell eNBs and relays may have a lower transmit power level (e.g., 0.1 to 2 Watts).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a mobile or portable terminal, a subscriber unit, a station, a smart phone, etc. A UE may be a cellular phone, a personal digital assistant (PDA), a wireless modem, a wireless communication device, a handheld device, a laptop computer, a cordless phone, a wireless local loop (WLL) station, or other mobile entities. A UE may be able to communicate with macro eNBs, small cell eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively. However, the present application is not limited to LTE or other specific wireless protocol.

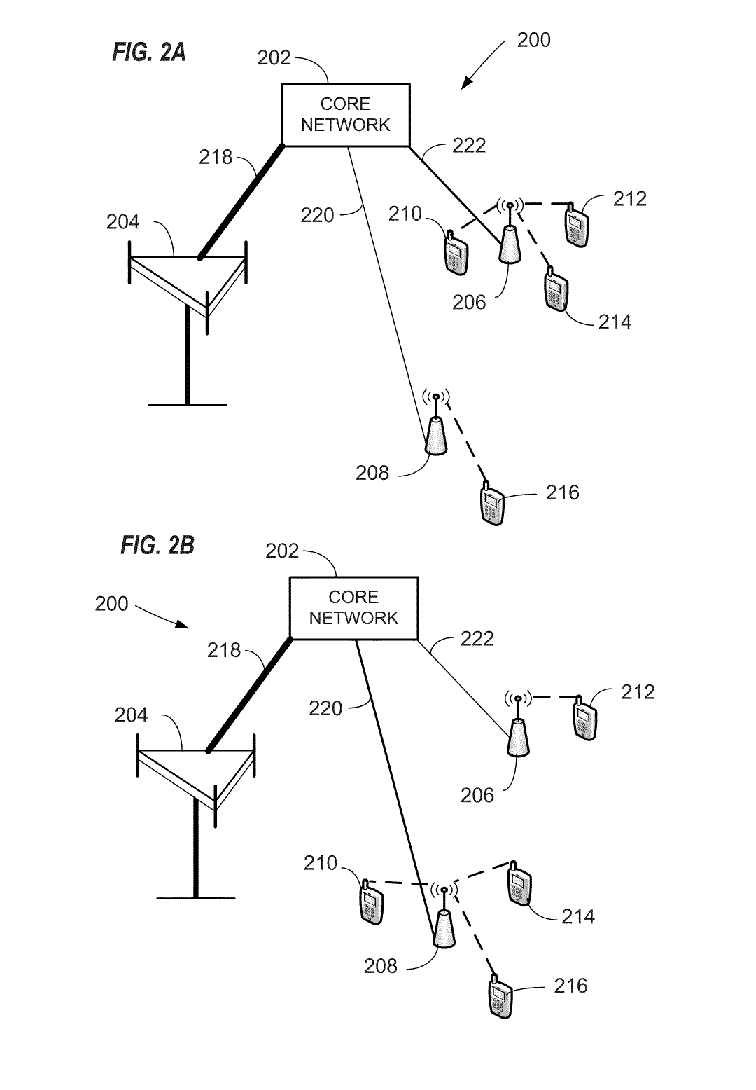

FIGS. 2A-2B illustrates backhauls and changes in demand in a radio neighborhood 200 including a macrocell 204 and two or more small cells 206, 208. The macrocell 204 may communicate with a core network 202 via a wired or wireless backhaul 218. The small cells 206, 208 may communicate with the core network 202 via respective wired or wireless backhauls 220, 222. The macrocell 204 may communicate with many mobile terminals (not shown). The small cells 208, 206 may service relatively small numbers of terminals, and accordingly the backhauls 220, 220 may be smaller than the backhaul 218, to preserve network resources and bandwidth of backhaul channels. At an earlier time illustrated in FIG. 2A, the small cell 206 services, or is being requested to service, three terminals 210, 212, 214, while the second small cell 208 is servicing a single terminal 216. The number of terminals shown in FIGS. 2A-2B is merely illustrative, and not limiting.

The small cells 206 and 208, alone or in cooperation with the core network 202, may configure their respective backhauls to adapt to a currently experience level of demand. The small cell 206, experiencing a relatively high level of demand as shown in FIG. 2A, may configure the backhaul 222 to service a higher demand level, or request configuration of the backhaul 222 to service higher demand from the core network 202. Meanwhile, the backhaul 220 may similarly be configured for lighter demand. If and when demand experienced by the small cells 206, 208 shifts, for example as illustrated in FIG. 2B in which small cell 208 is loaded three times more heavily than cell 206, configuration of the backhauls 220, 222 may be adapted in response to the shift in demand. While overall the backhaul traffic experienced by the core network 202 may be stable, bandwidth and traffic may be reallocated to the most optimal small cells, for example to accommodate longer term changes in location or use of small cells. This may avoid, for example, unnecessary costs associated with providing a high-bandwidth backhaul where it is not needed. It should be appreciated that many backhaul protocols are proprietary to different networks, and may use different channels (both wired and wireless) and different configurations depending on the intended application. However, existing networks cannot adapt backhaul configuration of small cells in response to shifts in demand that are detected by ongoing demand monitoring involving the small cells. The present technology may enable adaptation of the backhaul configuration to observed usage patterns of the small cell.

It should be appreciated, however, that difficulties or economic factors involved in changing backhaul configuration for consumer small cells may cause configuration changes to be relatively infrequent. For example, cells may be provided with upgraded backhauls only after extended periods (e.g., many days or longer) of high demand. Conversely, backhauls may tend to remain upgraded even if no longer justified by demand, because the costs of downgrading the backhaul configuration may exceed the benefits, if any, of doing so.

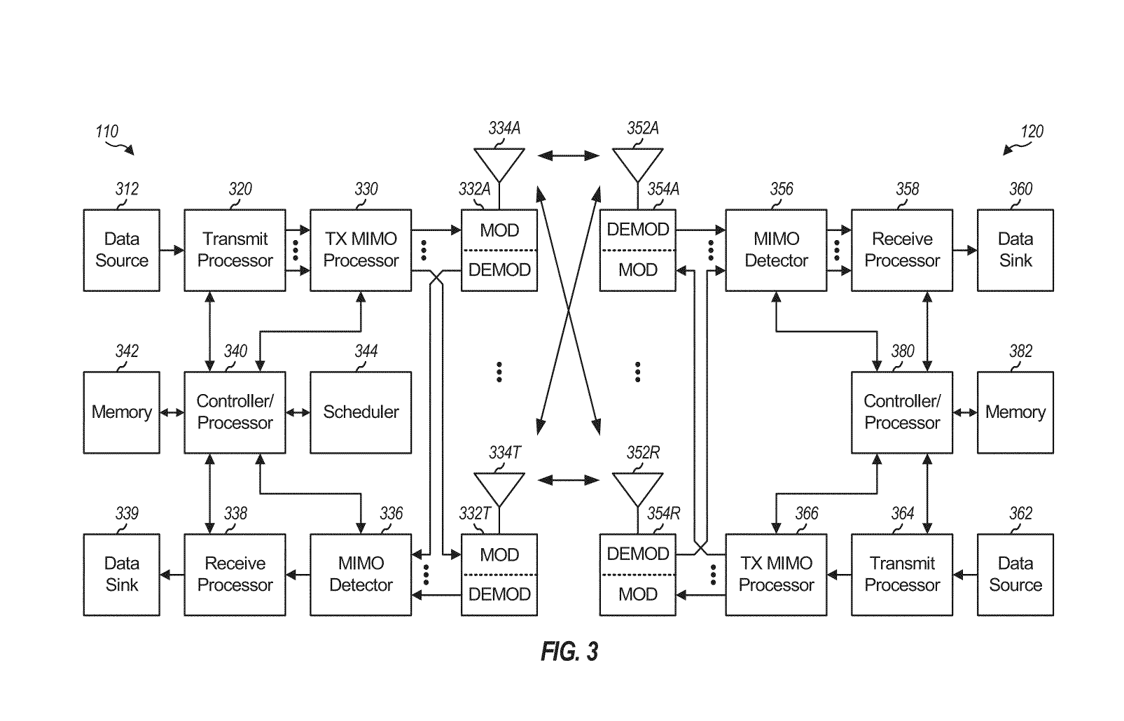

FIG. 3 shows a block diagram of a design of a base station/eNB 110 and a UE 120, which may be one of the base stations/small cells/eNBs and one of the UEs/mobile terminals in FIGS. 1-2. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCII, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCII) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

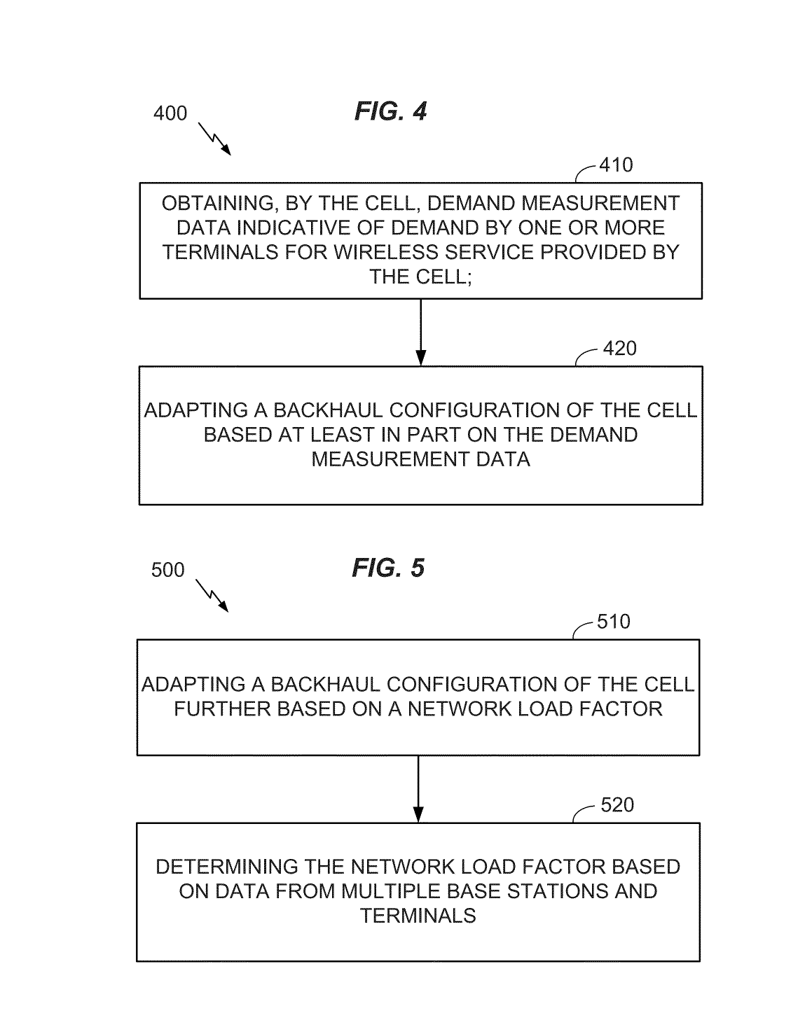

The controllers/processors 340 and 380 may direct the operation at the base station 110 and the UE 120, respectively. The processor 380 and/or other processors and modules at the UE 120 may also perform or direct the execution of the functional blocks illustrated in FIGS. 4-9, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

In the foregoing and similar contexts, for some operators, the business model for Neighborhood Small Cell deployments may involve subsidizing the consumer backhaul to enable better capacity gains. Operators may not want to do this for all small cell owners due to cost. Accordingly, it may be beneficial to have an autonomous algorithm for identifying small cells tending to optimize benefits due to this backhaul improvement or more generally, controlling backhaul configuration.

One proposed solution is to initially deploy the small cell in restricted access mode. The registration attempts of other users may be monitored to see if this small cell is in a favorable location to serve other users in the area. The total and unique number of registration attempts may both be utilized to determine whether it makes sense for the operator to subsidize the backhaul for this small cell owner. An alternative solution is to deploy the small cells in open or hybrid access mode initially. In this case, the total and unique number of users getting service, the number of non-CSG users getting service, and/or the total backhaul demand by the small cell may be monitored by the operator to determine whether the network would benefit from subsidizing (and potentially upgrading) the backhaul for this small cell owner. These statistics can be processed in a distributed manner by the small cell and a final decision of whether there is need for improved backhaul may be communicated to a central entity. Alternatively, statistics such as registration attempts, number of unique users, total data usage, or other demand data maybe communicated to a central entity which makes a determination regarding upgrading a consumer backhaul.

### EXAMPLE METHODOLOGIES AND APPARATUS

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored as encoded instructions and/or data on an article of manufacture to facilitate transporting and transferring such methodologies to various devices. Those skilled in the art will understand and appreciate that a method could alternatively be represented as a series of interrelated states or events, such as in a state diagram.

FIG. 4 shows a method 400 for adapting a backhaul configuration for a wireless communication cell. A backhaul configuration may include any one or combination of a backhaul channel, a backhaul protocol, or a signaling configuration selected from two or more defined signaling configurations of a backhaul protocol. The cell may be in a neighborhood including one or more small cells comprising low power base stations (e.g., femto node, pico node, Home Node B, etc.) of a wireless communications network. The method 400 may include, at 410, obtaining, by the cell, demand measurement data indicative of demand by one or more terminals for wireless service provided by the cell. Demand measurement data may include measurements indicating a number of terminals that are seeking, or may be seeking, to establish a connection to a network via the small cell, traffic volume, or other measures as discussed in more detail below. Demand measurement may be performed by the small cell, with demand data submitted to a network node for processing, for example, to a network node responsible for backhaul configuration. In an alternative, the small cell may process demand data.

The method 400 may include, at 420, adapting a backhaul configuration of the cell based at least in part on the demand measurement data. For example, a network node may test a measure of demand, or multiple measures of demand, against one or more threshold levels triggering changes in backhaul configuration or used in a look-up table to identify a most appropriate or optimal backhaul configuration for the small cell. In an alternative, each small cell may retain demand information, and determine an optimal backhaul configuration or a requested backhaul configuration based on the demand measurements, using a predetermined configuration selection algorithm.

The network may provision a new backhaul configuration for the small cell, which may automatically switch to using the new backhaul configuration as soon as it is ready for use. It should be appreciated that the operations 410, 420 may be performed at different times. For example, demand measurement 410 may be performed at periodic intervals, continuously, or semi-continuously, while adapting the backhaul configuration for a small cell 420 may be generally performed in response to changes in measured demand, as detected by ongoing demand measurement 410. In contrast, conventional backhaul configuration for a small cell is generally static once initially set up.

The method 400 may include additional aspects or operations 500, 600, 700, 800 or 900, as shown in FIGS. 5-9. These additional operations are not required to perform the method 400, and one or more may be omitted. Any one of these operations may be included as part of method 400, without necessarily requiring other upstream or downstream operations to also be included. Operations are grouped into different figures merely for illustrative convenience, and useful applications of the concepts disclosed herein are not limited to the illustrated groupings.

Referring to FIG. 5, the method 400 may include, at 510, adapting a backhaul configuration of the cell further based on a network load factor, in addition to the measure change in demand. For example, when the network is more highly loaded, threshold demand levels for adapting a backhaul for higher data rates may be increased. Conversely, when network load is low, threshold demand levels for adopting increased data rate configurations may be lowered. The method 400 may further include, at 520, determining the network load factor based on data from multiple base stations and terminals. For example, loadings from multiple eNBs may be aggregated to determine an overall network load. Network loads may include, for example, a percentage or ratio of available network bandwidth/data rate currently in use.

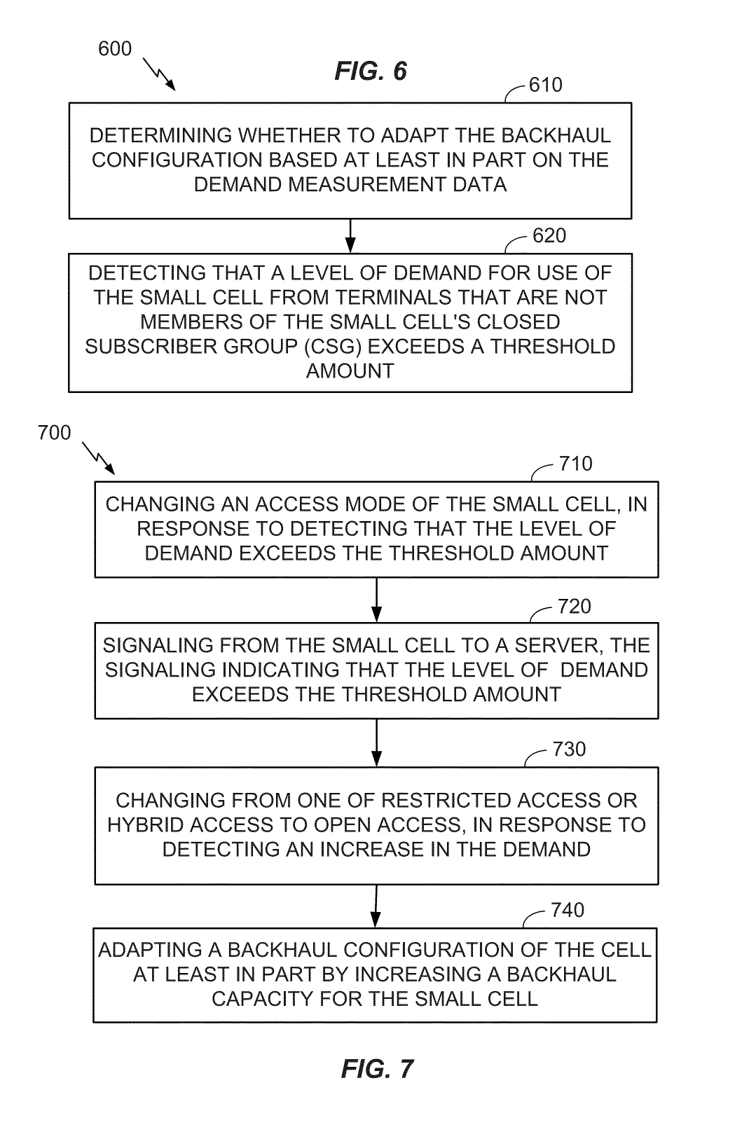

Referring to FIG. 6, the method 400 may include, at 610, determining whether to adapt the backhaul configuration, based at least in part on the demand measurement data. For example, the method may include, at 620, detecting that a level of demand for use of the small cell from terminals that are not members of the small cell's closed subscriber group exceeds a threshold amount, e.g., in a test loop or look-up table. In other words, a threshold test may be applied to demand data to determine whether reconfiguration of the backhaul is desirable. The foregoing measure of demand related to potential demand for the cell's services. This is a measure of demand from terminals that are prevented from being serviced by a small cell because they are not members of the small cell's CSG. Nonetheless it may be beneficial to service such terminals to offload other cells in the area, if possible without degrading service for terminals that are members of the CSG.

Referring to FIG. 7, the method 400 may include, at 710 changing an access mode of the small cell, in response to detecting that the level of demand exceeds the threshold amount. For example, the method may include, at 720, signaling from the small cell to a server, the signaling indicating that the level of demand exceeds the threshold amount. As a result of this indication, the server may trigger a procedure to increase the backhaul bandwidth. In an aspect, the procedure to improve backhaul may include a manual process performed by the small cell network operator. In the alternative, for example where the operator is closely integrated with the backhaul network service provider (e.g., Internet Service Provider), the server may instruct the backhaul capacity to be increased in a more automated fashion.

The method may further include, at 730, changing from one of restricted access or hybrid access to open access, in response to detecting an increase in the level of demand. For example, if in the level of demand increases and crosses a threshold, the small cell may reconfigure itself, or be reconfigured, from a restricted access or hybrid access configuration to open access. In such case, the method 400 may further include, at 740, adapting a backhaul configuration of the cell at least in part by increasing a backhaul capacity for the small cell. Increasing a backhaul configuration may include identifying a desired backhaul configuration based on the increase in demand level, and communicating the backhaul configuration between the small cell and a network entity or entities providing the backhaul to the small cell.

Conversely, referring to FIG. 8, the method 400 may include, at 810, changing the access mode at least in part by changing from open access to one of hybrid access or restricted access, in response to detecting a decrease in the demand. The method 400 may further include, at 820, adapting a backhaul configuration of the cell at least in part by decreasing a backhaul capacity for the small cell based on the changing from the open access configuration. Decreasing backhaul configuration may be implemented similarly to reconfiguring a small cell backhaul for handling an increase in demand.

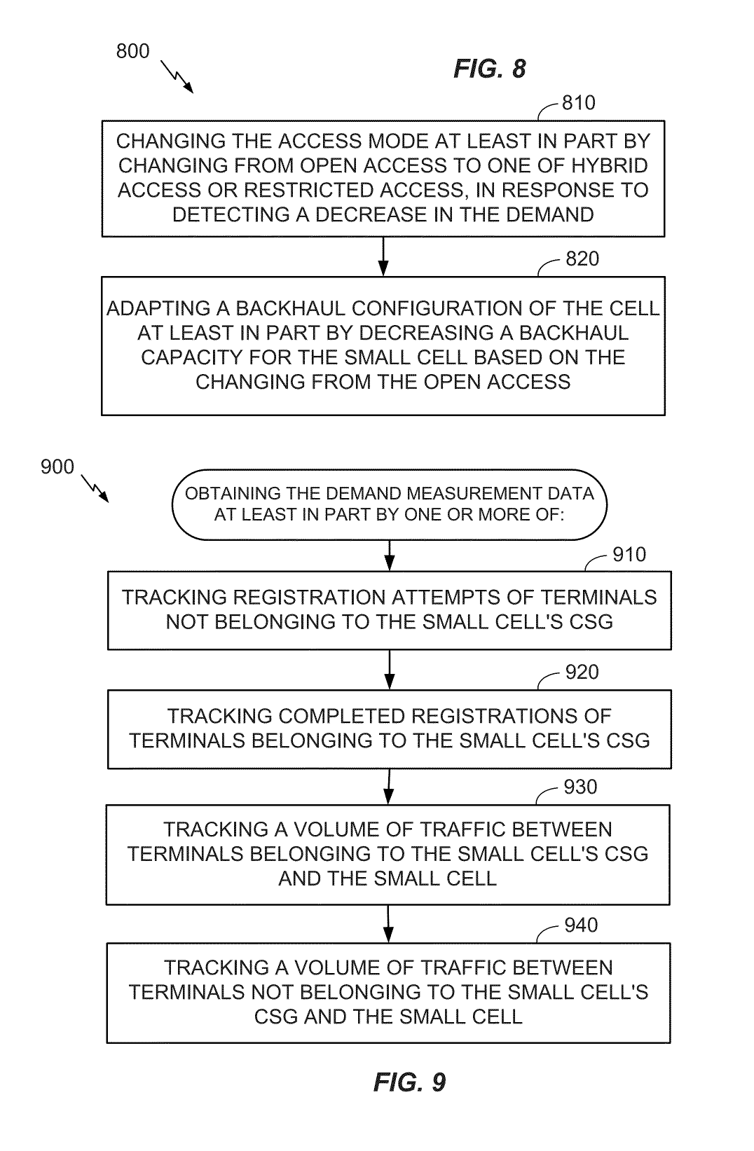

Various processes may be used for obtaining demand measurement data used for determining changes in backhaul configurations for small cells. Examples of such processes are illustrated in FIG. 9. The method 400 may include, at 910, obtaining the demand measurement data at least in part by tracking registration attempts of terminals not belonging to the small cell's CSG. In an alternative, the method 400 may include, at 920, tracking completed registrations of terminals belonging to the small cell's CSG. In the alternative, or in addition, the method may include, at 930, tracking a volume of traffic between terminals belonging to the small cell's CSG and the small cell. Likewise, in another option, demand measurement may include, at 940, tracking a volume of traffic between terminals not belonging to the small cell's CSG and the small cell.

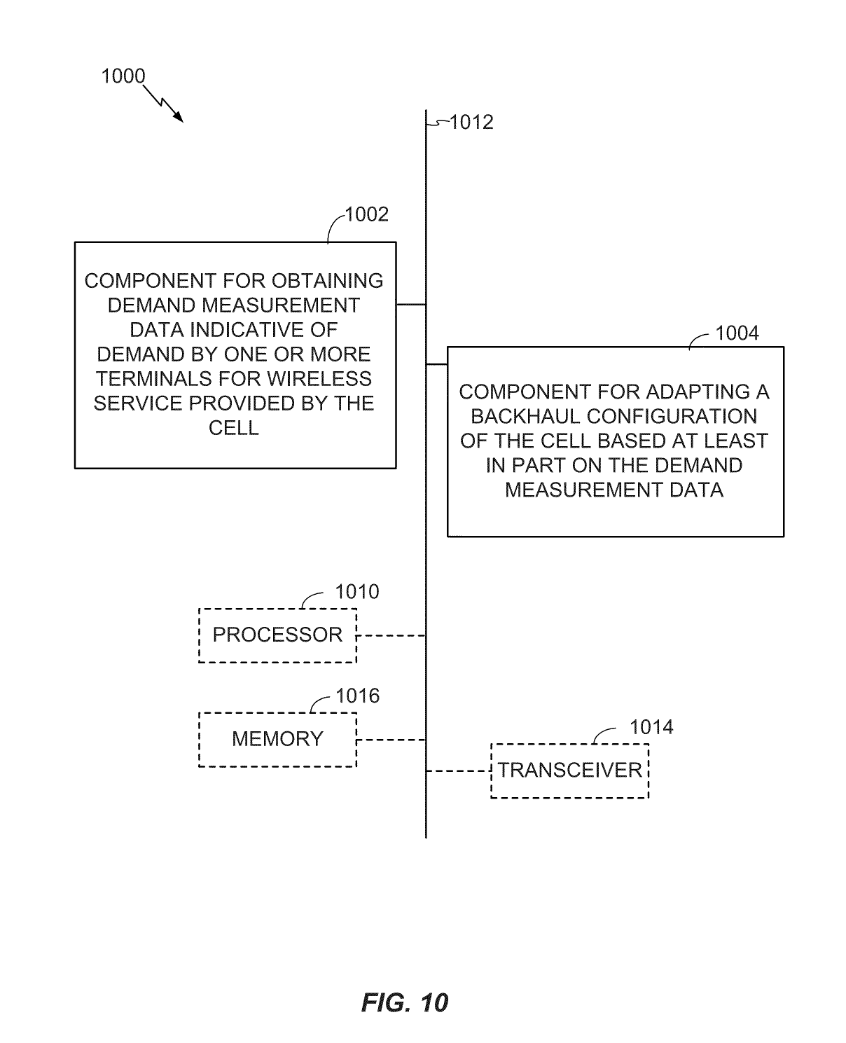

For further example, with reference to FIG. 10, there is depicted an apparatus 1000 that may be configured as a small cell in a wireless network, or as a processor or similar device for use within the small cell, and may include in some cases a network entity in communication with the small cell. The apparatus 1000 may include functional blocks that can represent functions implemented by a processor, software, hardware, or combination thereof (e.g., firmware).

As illustrated, in one embodiment, the apparatus 1000 may include an electrical component or module 1002 for obtaining demand measurement data indicative of demand by one or more terminals for wireless service provided by the cell. For example, the electrical component 1002 may include at least one control processor coupled to a transceiver or the like and to a memory with instructions for tracking registration attempts and/or traffic by CSG member terminals, or CSG non-member terminals. The component 1002 may be, or may include, a means for obtaining demand measurement data indicative of demand by one or more terminals for wireless service provided by the cell. Said means may include, for example, the control processor executing any one or more of the algorithms for obtaining demand measurement data as described in connection with FIG. 9.

The apparatus 1000 may include an electrical component 1004 for adapting a backhaul configuration of the cell based at least in part on the demand measurement data. For example, the electrical component 1004 may include at least one control processor coupled to a transceiver or the like and to a memory holding instructions for implementing different backhaul configurations based on current or anticipated demand indicated by demand measurement data. The component 1004 may be, or may include, a means for adapting a backhaul configuration of the cell based at least in part on the demand measurement data. Said means may include the control processor executing an algorithm, for example, looking up a backhaul configuration identifier based on current demand measurement data, sending the identifier from a network component to the small cell, or vice-versa, and initiating sending and receiving of data and control signals over a backhaul channel according to a backhaul protocol or configuration identified by the backhaul configuration identifier over a backhaul channel.

In related aspects, the apparatus 1000 may optionally include a processor component 1010 having at least one processor, in the case of the apparatus 1000 configured as a network entity. The processor 1010, in such case, may be in operative communication with the components 1002-1004 or similar components via a bus 1012 or similar communication coupling. The processor 1010 may effect initiation and scheduling of the processes or functions performed by electrical components 1002-1004. The processor 1010 may encompass the components 1002-1004, in whole or in part. In the alternative, the processor 1010 may be separate from the components 1002-1004, which may include one or more separate processors. It should be appreciated that the apparatus 1000 may perform functions of its components 1002, 1004 at different times. For example, demand measurement may be performed at periodic intervals, continuously, or semi-continuously, while adapting the backhaul configuration for a small cell (1004) may be generally performed in response to changes in measured demand.

In further related aspects, the apparatus 1000 may include a radio transceiver component 1014. A stand alone receiver and/or stand alone transmitter may be used in lieu of or in conjunction with the transceiver 1014. In the alternative, or in addition, the apparatus 1000 may include multiple transceivers or transmitter/receiver pairs, which may be used to transmit and receive on different carriers. The apparatus 1000 may optionally include a component for storing information, such as, for example, a memory device/component 1016. The computer readable medium or the memory component 1016 may be operatively coupled to the other components of the apparatus 1000 via the bus 1012 or the like. The memory component 1016 may be adapted to store computer readable instructions and data for performing the activity of the components 1002-1004, and subcomponents thereof, or the processor 1010, method 400, or the methods disclosed herein. The memory component 1016 may retain instructions for executing functions associated with the components 1002-1004. While shown as being external to the memory 1016, it is to be understood that the components 1002-1004 can exist within the memory 1016.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available non-transitory media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and Blu-Ray™ disc where disks usually encode data magnetically, while “discs” customarily refers to media encoded optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and features disclosed herein.

What is claimed is:

1. A method for adapting a backhaul configuration for a wireless communication cell, the method comprising:
obtaining, by the cell, demand measurement data indicative of demand by one or more terminals for wireless service provided by the cell; and
adapting a backhaul configuration of the cell based at least in part on the demand measurement data.

2. The method of claim 1, wherein the adapting a backhaul configuration of the cell comprises increasing a backhaul capacity for the small cell.

3. The method of claim 1, further comprising, by at least one of the cell or a server in communication with the cell, determining whether to adapt the backhaul configuration, based at least in part on the demand measurement data.

4. The method of claim 3, wherein the determining further comprises detecting a level of demand for use of the small cell from terminals that are not members of the small cell's closed subscriber group (CSG) that exceeds a threshold amount.

5. The method of claim 4, further comprising signaling from the small cell to a server, the signaling indicating that the level of demand exceeds the threshold amount.

6. The method of claim 4, further comprising changing an access mode of the small cell, in response to detecting that the level of demand exceeds the threshold amount.

7. The method of claim 6, wherein changing the access mode comprises changing from one of restricted access or hybrid access to open access, in response to detecting an increase in the demand.

8. The method of claim 6, wherein changing the access mode comprises changing from open access to one of hybrid access or restricted access, in response to detecting a decrease in the demand.

9. The method of claim 1, wherein obtaining the demand measurement data comprises tracking registration attempts of terminals not belonging to the small cell's closed subscriber group (CSG).

10. The method of claim 1, wherein obtaining the demand measurement data comprises tracking completed registrations of terminals belonging to the small cell's closed subscriber group (CSG).

11. The method of claim 1, wherein obtaining the demand measurement data comprises tracking a volume of traffic between terminals belonging to the small cell's closed subscriber group (CSG) and the small cell.

12. The method of claim 1, wherein obtaining the demand measurement data comprises tracking a volume of traffic between terminals not belonging to the small cell's closed subscriber group (CSG) and the small cell.

13. The method of claim 2, wherein adapting a backhaul configuration of the cell is further based on a network load factor.

14. The method of claim 2, wherein the determining whether to adapt the backhaul configuration, based at least in part on the demand measurement data is performed by the small cell.

15. An apparatus for wireless communication, the apparatus comprising:
means for obtaining demand measurement data indicative of demand by one or more terminals for wireless service provided by the cell;
means for adapting a backhaul configuration of the cell based at least in part on the demand measurement data.

16. An apparatus for wireless communication, comprising:
at least one processor configured for obtaining demand measurement data indicative of demand by one or more terminals for wireless service provided by the cell, and adapting a backhaul configuration of the cell based at least in part on the demand measurement data; and
a memory coupled to the at least one processor for storing data.

17. The apparatus of claim 16, wherein the at least one processor is further configured for adapting a backhaul configuration of the cell at least in part by increasing a backhaul capacity for the small cell.

18. The apparatus of claim 16, wherein the at least one processor is further configured for determining whether to adapt the backhaul configuration, based at least in part on the demand measurement data.

19. The apparatus of claim 18, wherein the at least one processor is further configured for performing the determining at least in part by detecting a level of demand for use of the small cell from terminals that are not members of the small cell's closed subscriber group (CSG) that exceeds a threshold amount.

20. The apparatus of claim 19, wherein the at least one processor is further configured for signaling from the small cell to a server, the signaling indicating that the level of demand exceeds the threshold amount.

21. The apparatus of claim 19, wherein the at least one processor is further configured for changing an access mode of the small cell, in response to detecting that the level of demand exceeds the threshold amount.

22. The apparatus of claim 21, wherein the at least one processor is further configured for the changing the access mode at least in part by changing from one of restricted access or hybrid access to open access, in response to detecting an increase in the demand.

23. The apparatus of claim 19, wherein the at least one processor is further configured for the changing the access mode at least in part by changing from open access to one of hybrid access or restricted access, in response to detecting a decrease in the demand.

24. The apparatus of claim 19, wherein the at least one processor is further configured for the obtaining the demand measurement data at least in part by tracking registration attempts of terminals not belonging to the small cell's closed subscriber group (CSG).

25. The apparatus of claim 19, wherein the at least one processor is further configured for the obtaining the demand measurement data at least in part by tracking completed registrations of terminals belonging to the small cell's closed subscriber group (CSG).

26. The apparatus of claim 19, wherein the at least one processor is further configured for the obtaining the demand measurement data at least in part by tracking a volume of traffic between terminals belonging to the small cell's closed subscriber group (CSG) and the small cell.

27. The apparatus of claim 19, wherein the at least one processor is further configured for the obtaining the demand measurement data at least in part by tracking a volume of traffic between terminals not belonging to the small cell's closed subscriber group (CSG) and the small cell.

28. The apparatus of claim 16, wherein the at least one processor is further configured for the adapting a backhaul configuration of the cell further based on a network load factor.

29. The apparatus of claim 28, wherein the at least one processor is further configured for determining the network load factor based on data from multiple base stations and terminals.

30. A computer program product, comprising non-transitory computer-readable medium holding instructions, that when executed by a processor, cause a computer to:
obtain demand measurement data indicative of demand by one or more terminals for wireless service provided by the cell; and
adapt a backhaul configuration of the cell based at least in part on the demand measurement data.
